(19) United States
(12) Patent Application Publication
(10) Pub. No.: US 2011/0178952 A1
(43) Pub. Date: Jul. 21, 2011

(54) SYSTEM, METHOD, AND PRODUCT FOR PROTECTING A REAL ESTATE VALUE

(76) Inventors: Kenneth L. Herzberg, New York, NY (US); Andrew J. Herzberg, New York, NY (US)

(21) Appl. No.: 13/008,560

(22) Filed: Jan. 18, 2011

Related U.S. Application Data
(60) Provisional application No. 61/295,486, filed on Jan. 15, 2010.

(51) Int. Cl. G06Q 40/00

(52) U.S. Cl. 705/36 R

(57) ABSTRACT

A computer program product, saved on a memory connected to a computer, to protect a purchase price of real estate to minimize liability risk associated with a loss of value of the real estate. The computer program product includes programs by which the computer executes a plurality of steps. The steps include selecting at least one inventory of real estate for processing and calculating a protected price of at least one unit of the selected at least one inventory. An exercise option for the at least one unit based on the start date and the protected price may be determined and an opt-out option based on the start date and the protected price may also be determined. At least one of (a) a first output or an exercise failure output based on the exercise option or (b) a second output or an opt-out failure output based on the opt-out option may be output.

### CROSS-REFERENCE TO RELATED APPLICATION

This application claims priority to U.S. Application No. 61/295,486 entitled “System and Method for Protecting Real Estate Values,” filed Jan. 15, 2010, which is incorporated herein by reference in its entirety.

### BACKGROUND

Today's real estate landscape is covered with a plurality of unsold inventories. Inventories offered at significantly reduced prices remain unsold while marketing and costs-of-carry continue to reduce developer's profits. Some of the extremely adverse market conditions are created by an erosion of consumer confidence, significant periods of over building, declining real estate values, and bank foreclosures. Most new developments have seen pre-sales vanish. Many developments are sitting in various stages of completion with potential buyers questioning the market's bottom. Developers are having to deal with over leveraged financing and severe interest payments.

There is a need to restore confidence by creating a product, system, and method to assist consumers in protecting real estate values with certainty, safety, and security. Such a new financial product may address issues that plague real estate markets and may help to restore confidence to this badly battered market. Developers that market their inventory with the protection program may have a competitive advantage at a time where there is an absence of price stability, comparables, and buyer enthusiasm.

### SUMMARY

Embodiments of the invention provide an innovative approach to protecting a buyers real estate investment by creating a product, system, and method that aids in protecting real estate values.

According to one embodiment, there is provided a computer program product, saved on a memory connected to a computer, to protect a purchase price of real estate to minimize liability risk associated with a loss of value of the real estate, wherein said computer program product includes programs by which the computer executes the steps of: selecting at least one inventory of the real estate inventory for processing; calculating a protected price of at least one unit of the selected at least one inventory; determining an exercise option for the at least one unit based on the start date and the protected price; determining an opt-out option based on the start date and the protected price; and outputting at least one of (a) a first output or an exercise failure output based on the exercise option or (b) a second output or an opt-out failure output based on the opt-out option.

According to another embodiment, there is provided a protection plan computer system for protecting a purchase price of real estate to minimize liability risk associated with a loss of value of the real estate, the system comprising: a host processor adapted to receive and transmit data; a datastore associated with the host processor, the datastore to receive and store data from the host processor, the data including information on at least one inventory of real estate, a start date for at least one unit of the at least one inventory, and predetermined threshold information, wherein the host processor includes computer executable instruction for: selecting the at least one inventory of real estate for processing; calculating and storing a protected price of the at least one unit in the datastore; determining and storing an exercise option in the datastore for the at least one unit based on the start date and the protected price; determining and storing an opt-out option in the datastore based on the start date and the protected price; and outputting at least one of (a) a first output or an exercise failure output based on the exercise option or (b) a second output or an opt-out failure output based on the opt-out option.

According to another embodiment, there is provided a method to protect a purchase price of real estate to minimize liability risk associated with a loss of value of the real estate, comprising: selecting at least inventory of real estate for processing by a computer; calculating and storing, by a computer, a protected price of at least one unit of the at least one inventory in a datastore; determining and storing, by a computer, an exercise option in the datastore for the at least one unit based on a start date and the protected price; determining and storing, by a computer, an opt-out option in the datastore based on the start date and the protected price; and outputting, by a computer, at least one of (a) a first output or an exercise failure output based on the exercise option or (b) a second output or an opt-out failure output based on the opt-out option.

A price protection plan is provided to participants which may require a protection plan entity to repurchase a buyer's or investor's real estate unit. A computer may identify assets suitable for the program. Examples of a suitable asset is, but not limited to, unsold real estate inventory. A purchase price may be established that includes the market value of the asset in addition to an embedded cost of the protection play system.

In order to facilitate embedding of the outlay, a developer may need to further reduce the offering price of the inventory units or may allow an increase to the current pricing by a number equal to the cost of the protection plan program.

A unit owner in the protection plan system may have the ability to elect an “exercise option” that would require the protection plan entity to purchase the owner's real estate unit at its original purchase price at a future date. By electing this exercise option, the property owner has indicated that they will remain in the protection plan program until the protection plan entity must re-purchase the owner's real estate unit in exchange of the title to the unit.

Alternatively, a unit owner may elect to “opt-out” of the program. In exchange for the obligation release for the entity to repurchase the unit, the unit owner receives a payout bonus equal to a percentage of the purchase price of the owner's unit. By electing this opt-out option, the unit owner releases the protection plan entity from the obligation to purchase the unit back from the owner at a future date. Instead, the unit owner receives a payout bonus based on the year the unit enters the opt-out option.

The unit owner may either enter the exercise option or the opt-out option. A unit owner may not be able to enter both programs. According to one embodiment, the options are mutually exclusive. The unit owner may first have the option to opt-out of the protection plan system and then, upon deciding not to opt-out of the program, the unit owner may enter the exercise option. The unit may have time restrictions on entering either program. If the unit owner fails to enter either program, the unit owner continues to keep title of the unit as any other owner of real estate, exclusive of any encumbrances, liens, mortgages, or the like on the unit.

### BRIEF DESCRIPTION OF THE DRAWINGS

The subject matter of the application will be more readily understood from the following detailed description when read in conjunction with the accompanying drawings, in which:

FIG. 1 is an overall flowchart of the system, product, and method, according to one embodiment of the invention;

FIG. 2 is a diagram showing a datastore and stored information, according to one embodiment of the invention;

FIG. 3 is table showing an index, according to an embodiment of the invention;

FIG. 4 is a table showing example inventories, according to an embodiment of the invention;

FIG. 5 is a basic flowchart, according to an embodiment of the invention;

FIG. 6 is a table showing examples of costs associated with the protection plan system, according to an embodiment of the invention;

FIG. 7 is a table showing example inventories, according to an embodiment of the invention;

FIG. 8 is table showing an index, according to an embodiment of the invention;

FIG. 9 is a table showing example inventories, according to an embodiment of the invention;

FIG. 10 is a table showing example inventories, according to an embodiment of the invention;

FIG. 11 is a basic flowchart, according to an embodiment of the invention;

FIG. 12 is a basic flowchart, according to an embodiment of the invention; and

FIG. 13 is table showing an index, according to an embodiment of the invention.

### DETAILED DESCRIPTION

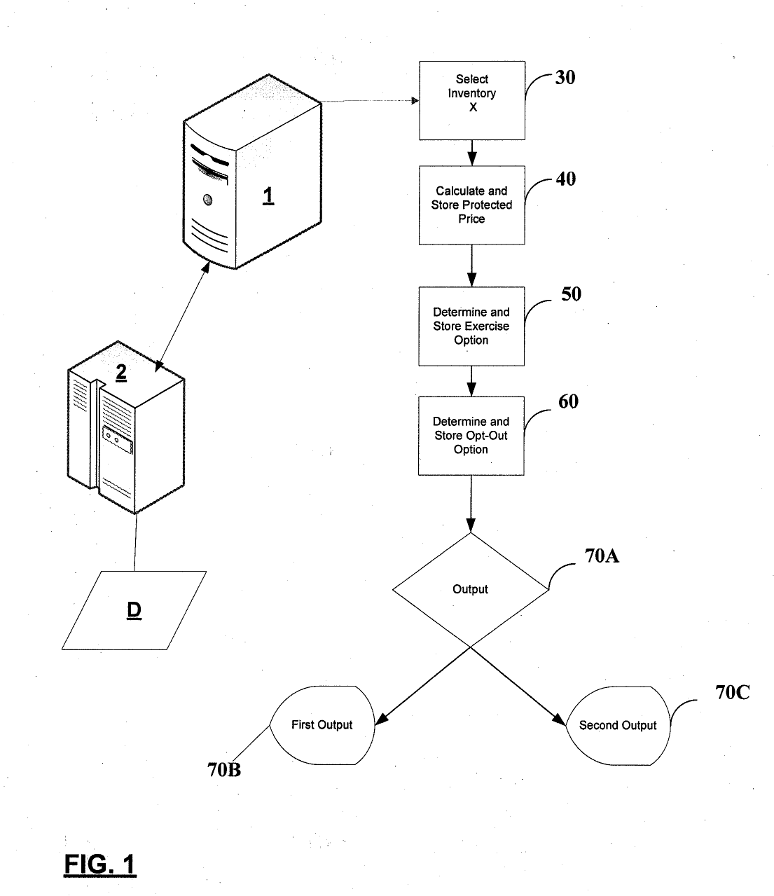

FIG. 1 provides an overall flowchart of the product, system, and method for protecting a purchase price of real estate to minimize liability risk associated with a loss of value of the real estate, according to an embodiment of the invention. A real estate unit may enter the protection plan system which embeds a protection plan into the purchase price of the unit. By entering into the program, the unit may be protected by future depreciation in the value of the unit. If the unit is selected for the protection plan system, the purchase price of the unit in the plan is determined. The unit has three mutually exclusive options in the protection plan.

The first option is that, at a future date (i.e., the exercise date), the unit may enter an “exercise option.” The exercise option mandates the sale of the unit at a specified date (exercise-action date) at the original purchase price, regardless of any depreciation of the unit. The protection plan guarantees that the unit will be sold to an entity of the protection plan system for the purchase price at the exercise-action date. In one embodiment, the exercise option must be entered into by a specified date (exercise date).

The second option is that, on an opt-out date, which is on or before the exercise date, the unit may enter an “opt-out option.” By entering the “opt-out option,” the unit owner essentially opts out of the first option described above. The opt-out option releases the protection plan entity from the obligation to purchase the unit at the purchase price on the exercise-action date, as described in the first option above. In exchange for the obligation release, a percentage of the purchase price is paid to the unit owner upon timely entering the opt-out option. The opt-out option must be entered by the opt-out date. There may be many opt-out dates available that correspond to varying percentages. The percentage may decrease as the opt-out dates approach the exercise date, as discussed below.

The third option is that the unit in the protection plan fails to enter either the exercise option or the opt-out option. No obligation will attach to the protection plan entity if the time period for entering the exercise option and the opt-out option lapses. The unit owner is free to sell their unit as they would under normal conditions.

Turning to FIG. 1, a host processor 1 is provided and is coupled to a datastore 2. The host processor 1 may comprise a computer. A computer system may comprise the host processor 1. The host processor 1 is adapted to receive and transmit data D. The host processor may store the data D in the datastore 2 and may recall the data D at a later time.

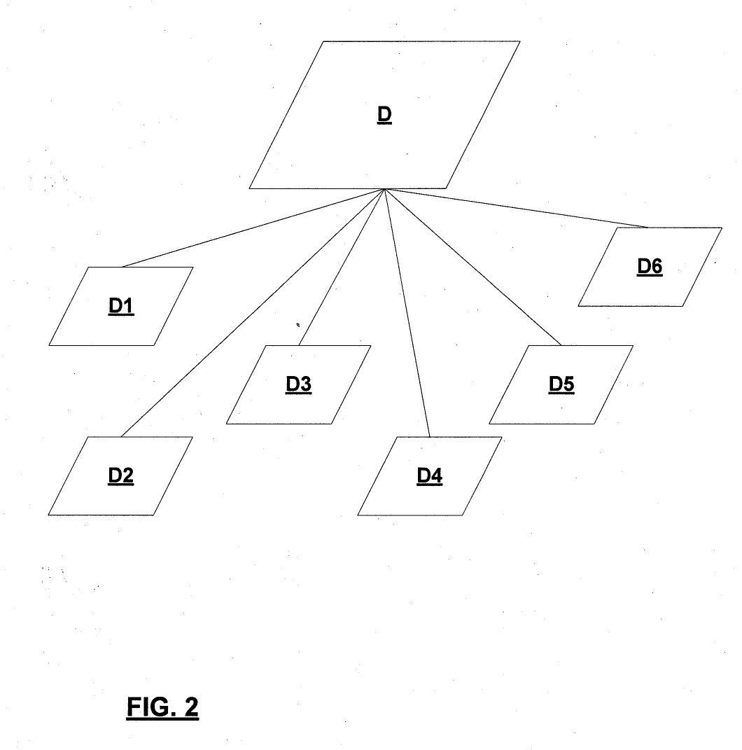

As provided in FIG. 2, the data D may include information (i.e., D1, D2, D3, D4, D5, D6, etc) regarding real estate inventories and the real estate industry. An example of a real estate inventory is a condo building that may include one or a plurality of individual units. The stored information D1 may include detailed information regarding the inventory of real estate such as, but not limited to, the number of units N of in the inventory, a number or percentage of units sold in the inventory V, the price per square foot of the units P, and other relevant information, such as, the S & P Case-Shiller Home Index information.

### Selecting the at Least One Inventory for Further Processing

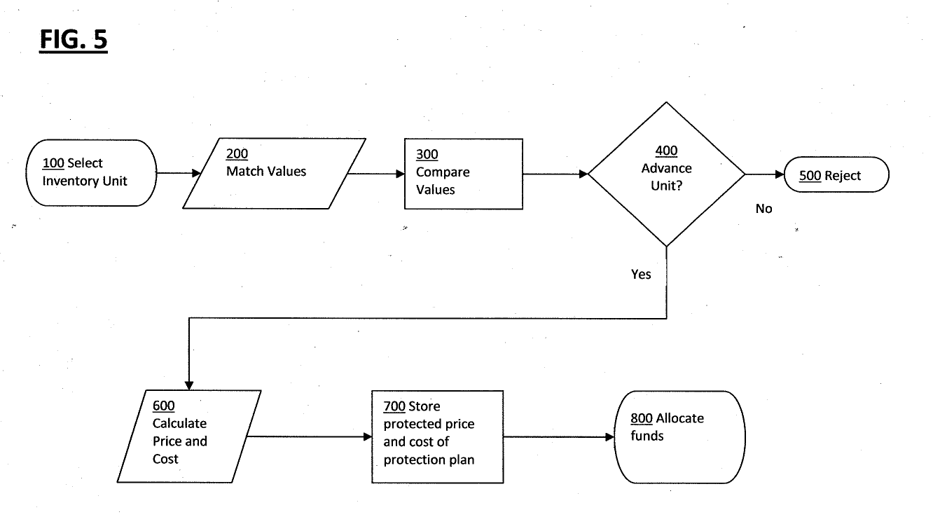

According to an embodiment of the invention, an inventory of real estate may be selected for processing 30 to enter a protection plan system, as provided in FIGS. 1 and 5. The data D stored in the datastore 2, such as the number of units N of the inventory, the value V of the number of units already sold of the inventory, and the price per square foot of the units P, may be selected by the host processor 1 for further processing in the protection plan system. Such data may be compared to an index of predetermined threshold values to determine whether the inventory should be further processed for the protection plan system.

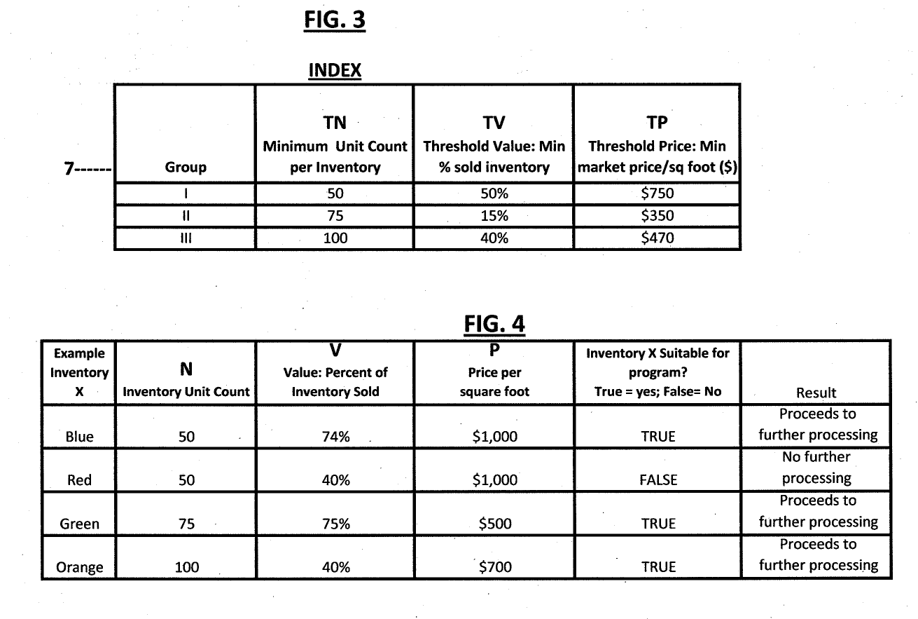

FIG. 3 provides an example index 7 of predetermined threshold values stored in the datastore 2. The index 7 may comprise a lookup table of individual threshold inventories. Groups I-III represent three sample inventories. Each threshold inventory may have an associated minimum threshold unit count TN, an associated minimum threshold value TV, and an associated threshold minimum price per square foot TP, as provided in FIG. 3. The threshold value TV may be the number of the units sold in the inventory.

According to an embodiment of the invention, the selection of an inventory, for example inventory X, for further processing 30 may include matching the unit count N of the inventory X to a corresponding threshold unit count TN. Once the unit count is matched to the appropriate threshold unit count (N=TN), the host processor 1 may then compare other associated information of the inventory X to threshold information. Such comparison may include a comparison between the value V of the units sold in the inventory X to a threshold value TV. The comparison may also include a comparison of the price per square foot P of the units to a threshold price per square foot TP.

An inventory may be selected for further processing if both the value V of the units is greater than or equal to the threshold value TV and the price per square foot P is greater than or equal to the threshold price per square foot TP, as shown by the following if-then statement:

If (V≧TV) AND (P≧TP), then inventory is selected further processing.

Other methods of comparison and calculation may be considered in the selection for further processing.

FIG. 4 provides examples of inventories (Blue, Red, Green, and Orange) with associated information stored in the datastore 2. Example Inventory Blue has a unit count N of 50 units. The Blue inventory value V is seventy-four percent (74%). This means that 74% of the unit count N are sold. Therefore, 37 units of Inventory Blue already are sold and 13 units remain unsold. As shown in column P of FIG. 4, the units of Inventory Blue have a price per square foot of $1,000/ft².

According to an embodiment of the invention, the Blue Inventory unit count N (50 units) is matched to the appropriate threshold unit count TN of FIG. 3. Group I of FIG. 3 corresponds to the threshold unit count TN (50 units). Thus, Group I is matched with the Blue Inventory for further analysis because N=TN.

The threshold value TV and the threshold price TP of Group I are next compared with the Blue Inventory value V and the Blue Inventory price per square foot P, respectively. The Blue value V of the units (74%) is greater than or equal to the threshold value TV (50%) of Group I. The Blue price per square foot P ($1,000) is greater than or equal to the threshold price per square foot TP ($750) of Group I. Since both V≧TV AND P≧TP, the Inventory Blue is selected for the further processing.

FIG. 4 provides other examples with Inventory Red, Inventory Green, and Inventory Orange each having a unit count N of 50 units, 75 units, and 100 units, respectively. Similar to the example with Inventory Blue above, a similar logic process may be conducted for these examples.

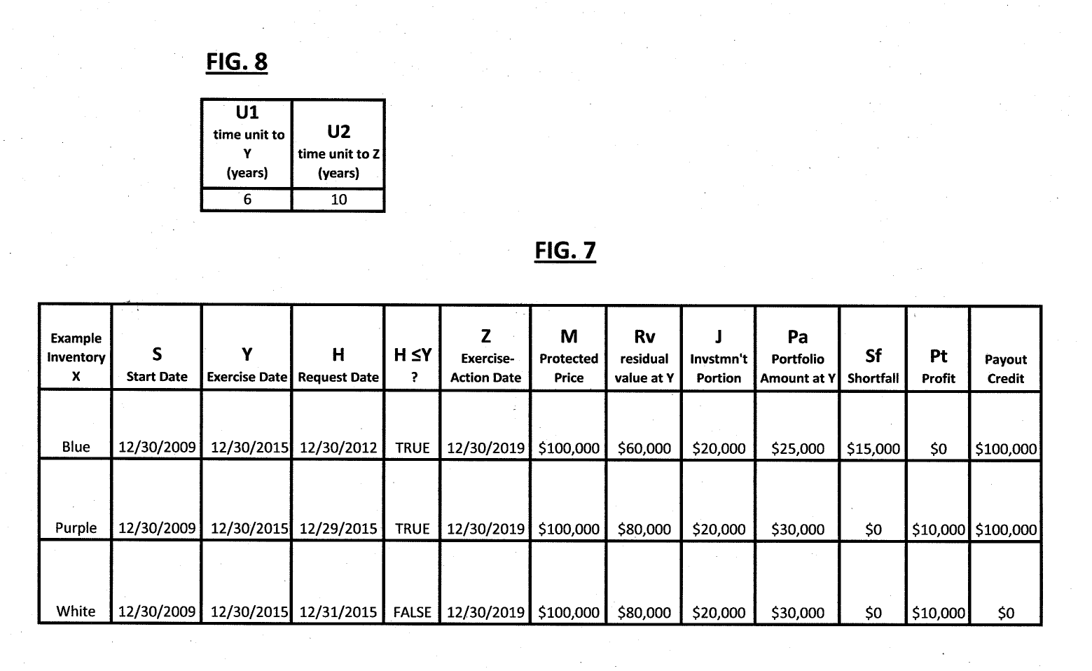

FIG. 5 provides a basic flowchart of the selection of a unit 30, according to one embodiment of the invention described above. As provided in the figure, a unit is selected 100, values are matched 200, the values are compared 300, and determination occurs 400 to either advance the unit for further processing or reject the unit 500 from the protection plan system. The next steps depicted on FIG. 5 (calculate price and cost 600, store protected price and cost of protection plan 700, and the allocation of funds 800) are further described in the paragraphs below. FIG. 5 follows the same logical flow as FIG. 7 discussed below.

### Calculate and Store a Protected Price

The host processor 1 is further adapted to calculate a protected price of at least one unit of an inventory and further adapted to store the protected price in the datastore 2, as provided in 40 of FIG. 1. The protected price M represents the price of a unit in the protection plan system. The protected price M may also be the price of the unit at closing on the unit of real estate. The actual cost of the protection plan K may be embedded into the protected price of the unit. The embedding of the cost K may be structured in a plurality of ways.

A base price B of a unit may first be calculated prior to calculating the protected price M. The base price B of a unit may be calculated by multiplying the price per square foot P by a square footage F of the unit. Thus, B=P*F. The information D2 stored in the datastore 2 may include the square footage F of each unit of the inventory. The host processor 1 may subsequently store the base price B in the datastore 2.

In a first embodiment, a premium cost factor C is used for embedding the cost K into the protected price M. The premium cost factor C may vary and for example, may range approximately between 0 and 25%. Other percentages may be contemplated. The factor C may be stored in the datastore 2. The base price B and the premium cost factor C may then be used to calculate the protected price M of the unit.

According to the first embodiment of the invention, the protected price M may be calculated by multiplying the base price B by 1 plus the premium cost factor. Therefore, the protected price M may be calculated as follows: M=B*(1+C).

Based on this first embodiment, the actual cost of the protection plan system K is the base price multiplied by the premium cost factor (K=B*C). The host processor 1 may store the protected price M and the cost of the protection plan system K in the datastore 2.

According to a second embodiment of the invention, the protected price M may be the base price B of the unit (M=B). In order to determine a cost of the protection plan system K, the host processor 1 may multiply the base price B by a discount factor T stored in the datastore 2.

Accordingly, in this second embodiment, the cost of the protection plan system is K=B*T. The host processor 1 may store the protected price M and the cost of the protection plan system K in the datastore 2. In this second embodiment, a developer selling the units of inventory may pay for the cost of the protection plan system to keep the purchase price of the units the same as the market value of the units (M=B).

Other methods of calculating the protected price M and the cost of the protection plan system K may be considered in other embodiments of the invention.

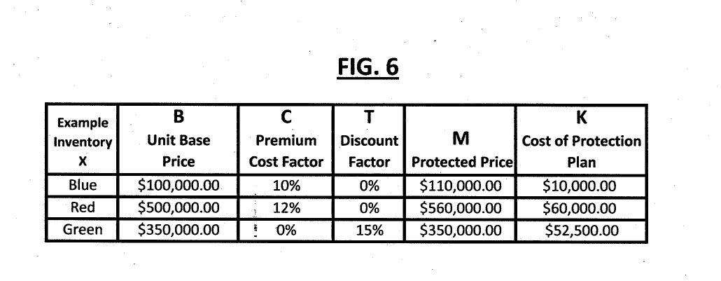

FIG. 6 provides examples of determining the protected price M and the cost of the protection plan K. Three example inventories are provided as inventories Blue, Red, and Green. The protected price M and the cost of the protection plan K follow the formulas described above.

For instance, for the first embodiment, considering the unit for the Blue Inventory:

B=$100,000 C=0.10 (10%) T=0
M=B*(1+C) K=B*C
M=$100,000*(1+0.10) K=$100,000*0.10
M=$110,000 K=$10,000

### Determine and Store an Exercise Option

The host processor 1 is further adapted to determine an exercise option E for at least one unit based on a start date S and the protected price M, as depicted in step 50 of FIG. 1. The exercise option E may then be stored in the datastore 2. The start date S may be the date of closing on a unit of real estate which may correspond to the date that the unit is entered into the protection plan. An exercise date Y and an exercise-action date Z may be determined based on the start date S.

The host processor 1 may determine the exercise date Y and the exercise-action date Z by adding different units of time U to the start date S. The start date S and the time unit U may be stored in the datastore 2. For instance, the exercise date Y may comprise the start date S plus a first unit of time U1. Similarly, the exercise-action date may comprise the start date S plus a greater second unit of time U2. Thus, Y=S+U1 and Z=S+U2. The second time unit U2 may always be greater than U1 so that the exercise-action date Z is a date farther in time than the exercise date Y. The host processor 1 stores the exercise date Y and the exercise-action date Z in the datastore 2 and associates the respective inventory unit with both Y and Z.

FIGS. 7 and 8 provide a table of examples of the above concept. As shown in the Figures, for this example, the first unit of time U1 is 6 years whereas the second unit of time U2 is 10 years, U1=6 and U2=10. The Inventory Blue of FIG. 7 has a start date of Dec. 30, 2009, S=Dec. 30, 2009. Thus, Inventory Blue has an exercise date Y and an exercise-action date Z as follows:
Y=S+U1 Z=S+U2
Y=Dec. 30, 2009+6 years Z=Dec. 30, 2009+10 years
Y=Dec. 30, 2015 Z=Dec. 30, 2019

Thus, Inventory Blue has an exercise date of Dec. 30, 2015 and an exercise-action date of Dec. 30, 2019. Other examples are provided in FIGS. 7 and 8 with Inventories Purple and White. The other columns of FIG. 7 will be discussed below.

### Determine and Store an Opt-out Option

The host processor 1 may be further adapted to determine an opt-out option L and store the opt-out option L in the datastore 2, as depicted in step 60 of FIG. 1.

At least one opt-out date O for a respective unit may be determined by adding a third time unit U3 stored in the datastore 2 to the start date S. Thus, O=S+U3. The host processor 1 then associates the opt-out date O with the respective inventory unit and stores the opt-out date O in the datastore 2.

The host processor 1 may also calculate an opt-out payment R by multiplying the protected price M by an opt-out percentage stored in the datastore 2. The opt-out payment R is stored in the datastore 2 and may be associated with the opt-out date O. A respective unit may have a plurality of opt-out dates and associated opt-out payments. A unit may only enter the opt-out option L within the first predetermined number of years of the protection plan program.

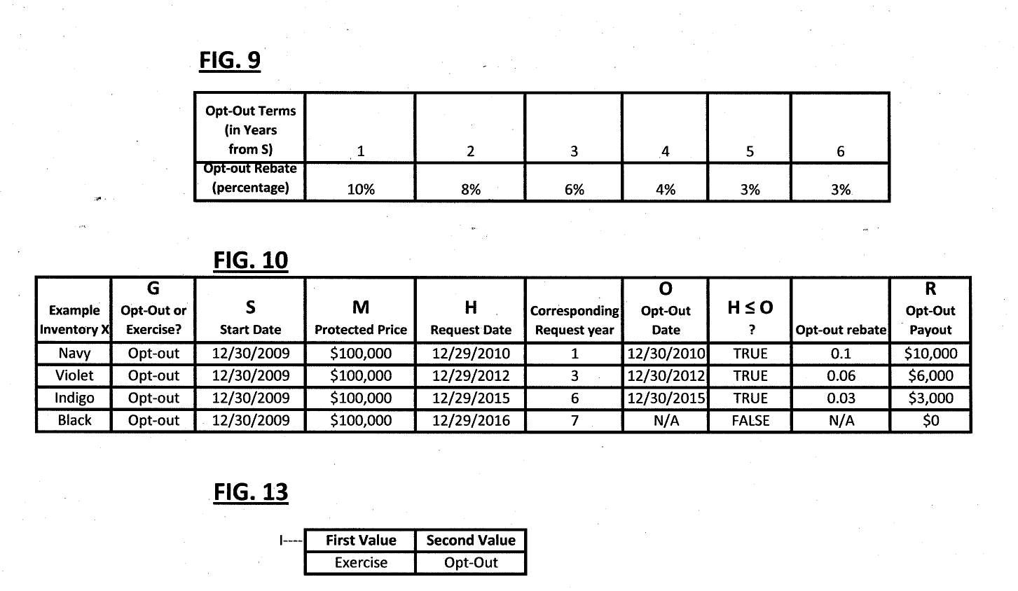

FIG. 9 provides an example of a payout schedule for each year past the start date up to six years. In this example, the unit may only enter the opt-out option L within the first six years of the protection plan program. For example, in entering the opt-out option in the first year, the table provides a 10% payout of the protected price. In entering the opt-out option in the fifth year, the table provides a 3% payout of the protected price. In this example, the opt-out option L expires after the sixth year.

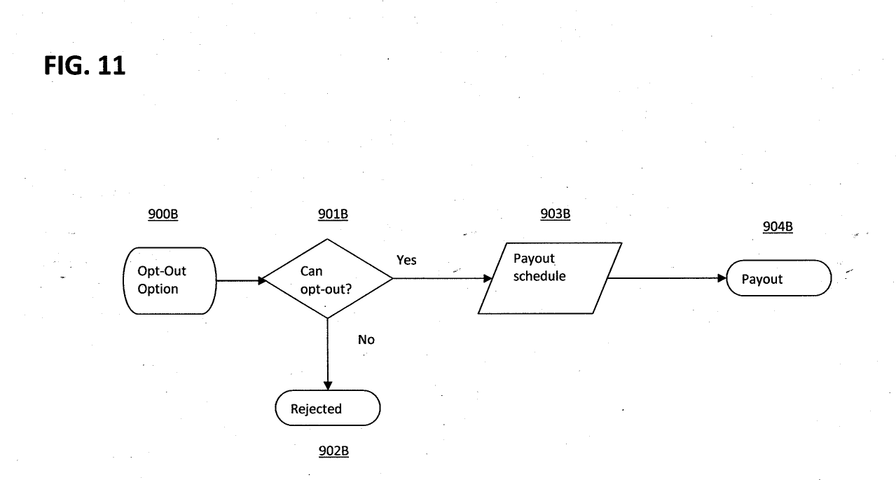

FIG. 11 provides a basic flowchart of the logical steps of FIG. 9 according to one embodiment of the invention described above. FIG. 11 demonstrates that a unit elects to enter the opt-out option 900B and a determination occurs if the unit is eligible to enter the opt-out option 901B. If the unit is not eligible, the unit is rejected 902B for this option. If the unit is eligible, the opt-out election is accepted and the payout schedule determines the percentage owed 903B. The unit owner is paid a percentage of the protected price and the protection plan entity is released of any obligation to purchase the unit at a future date 904B.

### Output

The host processor is adapted to output at least one of (a) a first output or an exercise failure output based on the exercise option or (b) a second output or an opt-out failure output based on the opt-out option, as depicted in steps 70A, 70B, and 70C of FIG. 1. As previously discussed, a unit of inventory may enter the exercise option, the opt-out option, or may not enter either option. The information D4 of the datastore 2 may include a request-option G, a request-date H, and an option index I to assist in the determination of the output. Each request-option G for a unit is associated with a respective request-date H. The request-option G may comprise either entry of the exercise option E or entry of the opt-out option L for a unit.

The request-option G and its associated request-date H may have certain restrictions and may be compared with threshold information D5 previously stored in the datastore 2. Such threshold information D5 may include an option index I with a first value FV associated with the exercise option E and a second value SV associated with the op-out option L.

The request option G, stored in the datastore 2, may be “exercise” or “opt-out.” Thus, (G=exercise) or (G=opt-out). The request option G may be compared to the first value FV and the second value SV of the option index I. The first value FV may be “exercise” whereas the second value SV may be “opt-out,” as depicted in FIG. 13. Thus, (FV=exercise) and (SV=opt-out). The request-option G is matched with one of the first value FV or the second value SV. For example, the request option G may be “opt-out” such that (G=opt-out). The host processor 1 matches the request option G with the corresponding entry in the option index I. Since (SV=opt-out), the request option G is matched with the second value SV.

The first value FV may be associated with the exercise date Y and the exercise-action date Z, previously explained above. The exercise date Y is the last day that the unit may enter the exercise option E. Therefore, in order for a unit to enter the exercise option E, the request date H must precede or be equal to the exercise date Y. Thus, (H Y).

If the request option matches the first value (G=FV) and the request date precedes or is equal to the exercise date (H≦Y), then the unit may enter the exercise option E. Accordingly, after the comparison, the host processor 1 outputs a first output when (G=FV) and (H≦Y). The first output may be a command or signal that the unit has entered exercise option E validly and may output the exercise-action date Z.

In contrast, if the request option matches the first value (G=FV) and the request date exceeds the exercise date (H≧Y), then the unit may not enter the exercise option E. Accordingly, after the comparison, the host processor 1 outputs an exercise failure output when (G=FV) and (H≧Y). The exercise failure output may be a command or signal that the unit is not eligible for the exercise option E.

If the request option G matches the second value (G=SV), the unit may be eligible for the opt-out option L. The second value SV may be associated with the at least one opt-out date O and opt-out payment R. The opt-out date O is the last day that the unit may exit the protection plan system in exchange for an associated opt-out payment R. There may be a plurality of opt-out dates with associated opt-out payments. The amount of the opt-out payments may compensate with the opt-out dates such that the later the opt-out date, the smaller the opt-out payment, see for example the table of FIG. 9.

If the request option matches the second value (G=SV) and the request date precedes or is equal to the opt-out date (H≦O), then the unit may enter the opt-out option L. Accordingly, after the comparison, the host processor 1 outputs a second output when (G=SV) and (H≦O). The second output may be a command or signal that the unit has entered opt-out option L validly and may output the opt-out payment R.

In contrast, if the request option matches the second value (G=SV) and the request date exceeds the opt-out date (H≧O), then the unit may not enter the opt-out option L. Accordingly, after the comparison, the host processor 1 outputs an opt-out failure output when (G=FV) and (H≧O). The opt-out failure output may be a command or signal that the unit is not eligible for the opt-out option L.

FIGS. 9 and 10 provide a table with examples of the above concept. Inventory Navy of FIG. 10 has a start date of Dec. 30, 2009 with a protected price of $100,000 and has elected the opt-out option. Thus, (S=Dec. 30, 2009) and (M=$100,000) and (G=opt-out). Inventory Navy has a request date H of Dec. 29, 2010 (H=Dec. 29, 2010). The request date H is within one year of the start date and therefore is prior to the Opt-Out date of Dec. 30, 2010. Since the Dec. 29, 2010 precedes Dec. 30, 2010 (H≦O), Inventory Navy has validly entered the Opt-out Option L. Based on the payout schedule of FIG. 9, Inventory Navy is entitled to an opt-out payout R of 10% of the protected price M. Accordingly, Inventory Navy is entitled to R=$100,000*10%=$10,000.

In contrast, Inventory Black is not eligible to enter the opt-out option L because the time period has expired to enter this option. Inventory Black has a start date of Dec. 30, 2009 with a protected price of $100,000 and has elected the opt-out option. Thus, (S=Dec. 30, 2009) and (M=$100,000) and (G=opt-out). Inventory Black has a request date H of Dec. 29, 2016 (H=Dec. 29, 2016). However, the request date H is greater than the maximum of 6 years to enter the opt-out option. Since the Dec. 29, 2016 exceeds the maximum date to enter the program (in this case Dec. 30, 2015), Inventory Black is not eligible for the opt-out program due to H≧O. Inventory Black is not entitled to any opt-out. Other examples are provided in FIGS. 9 and 10 with Inventories Violet and Indigo.

### Cost of the Protection Plan System

As previously described, the protection plan system has a cost K. In one embodiment, the cost of the protection plan system K is the base price B multiplied by the premium cost factor C, as follows: K=B*C. In a second embodiment, the cost of the protection plan system may the base price B multiplied by the discount factor T, as follows: K=B*T. Other embodiments for calculating the cost K may be contemplated.

An operational portion A of the cost K may be allocated to pay for debts or liabilities, such as, but not limited to, overhead and fees. An investment portion J of the cost K may be allocated for investment purposes to cover other debts or liabilities, such as, but not limited to, future opt-out payments R or potential shortfalls.

Thus, the cost of the protection plan system may comprise the operational portion A and the investment portion J, as follows: K=A+J.

The host processor 1 may calculate the operational portion A by multiplying an operational factor by the cost of the protection plan K, as follows: A=factor*K. The host processor 1 may then store the operational portion A in the datastore 2. Further, the host processor 1 may calculate the investment portion J by subtracting the operational portion from the cost of the protection plan, as follows: J=K−A.

After a period of time, a unit may enter the exercise option E. This causes the unit to be purchased from an owner at a future exercise-action date Z at the protected price M. The host processor 1 may determine whether the protection plan system for the unit was a profit or a shortfall.

The datastore 2 may include a residual value Rᵥ of the at least one unit and a portfolio amount Pₐ based on the investment amount. The residual value Rᵥ may be the market value of the unit at the exercise-action date Z. The residual value Rᵥ may be the same, higher, or lower than the protected price M. To compensate for a Rᵥ that is less than the protected price M, the investment portion J is invested to cover future depreciation of the unit. At the exercise-action date Z, the original investment portion J may have stayed the same, increased, or decreased. The portfolio amount Pₐ is the investment portion J at the exercise date Z. Therefore, the portfolio amount Pₐ may be the same, higher, or lower than the investment portion J.

The host processor may determine a profit Pₜ or a shortfall S_{f} based on the residual value Rᵥ and the portfolio amount Pₐ. A Result is calculated by adding the portfolio amount Pₐ to the residual value Rᵥ, as follows: Result=Pₐ+Rᵥ.

The host processor may store the Result in the datastore 2 as the profit Pₜ, if the Result is greater than or equal to the protected price M, as follows:
If Result≧M, then Result=Pₜ.

The host processor may store the Result in the datastore 2 as the shortfall S_{f}, if the Result is less than the protected price M, as follows:
If Result<M, then Result=S_{f}.

The host processor may output the Result as the profit Pₜ or shortfall S_{f} along with the value of the Result.

FIG. 7 provides a table of examples of the additional above concepts. As previously discussed, Inventory Blue of FIG. 7 may validly enter the exercise-option E. Inventory Blue has a protected price of $100,000 (M=$100,000). The investment portion J of the unit is $20,000. At the exercise-action date Z, the unit has a residual value Rᵥ of $60,000 and the portfolio amount Pₐ is $25,000. Therefore, the unit has decreased in value but the investment portion J has increased in value by $5,000. The Result is thus,

$$\begin{matrix}Result = {P}_{a} + {R}_{V} \\ = \$25 , 000 + \$60 , 000 \\ = \$85 , 000\end{matrix}$$

In determining whether the Result is a profit or a shortfall, the processor may determine either (i) Result≧M or (ii) Result<M. In this example, the second statement (ii) is appropriate, as follows:
Result<M
$85,000<$100,000

Thus, since Result<M, the Result is a shortfall (Result=S_{f}). In order for the protection plan entity to purchase back the Inventory Blue at the exercise-action date Z, the protection plan entity must make up the shortfall of $100,000−$85,000=$15,000. In summary, Inventory Blue is entitled to the $100,000 payout credit at Z in exchange for the title of the Inventory Blue unit. Other examples are provided in FIGS. 7 and 8 with Inventories Purple and White.

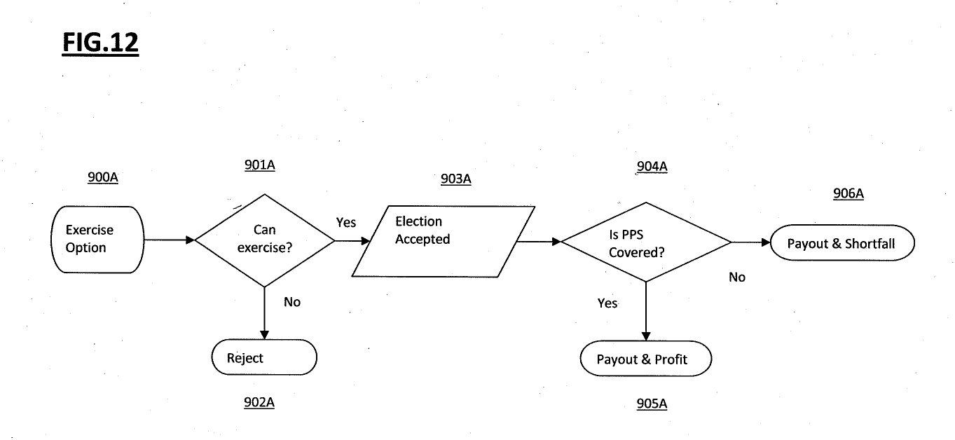

FIG. 12 provides a basic flowchart of the logical steps of FIG. 7 according to one embodiment of the invention described above. FIG. 12 demonstrates that a unit elects to enter the exercise option 900A and a determination occurs if the unit is eligible to enter the exercise option 901A. If the unit is not eligible, the unit is rejected 902A from this option. If the unit is eligible, the election is accepted 903A. A determination occurs if the protection plan entity is covered by the residual value and the portfolio amount 904A. If the residual value and the portfolio amount covers the protected price of the unit, the transaction is considered a profit and the protection plan entity credits the owner of the unit the protected price in exchange for the title of the unit 905A. In contrast, if the residual value and the portfolio amount fails to cover the protected price of the unit, the transaction is considered a shortfall. The protection plan entity still credits the owner of the unit the protected price in exchange for the title of the unit 905A.

Other factors such as, but not limited to, inflation, interest, future present value, and the like may be considered and factored into any of the calculations described in detail above. The above description was provided without these factors for simplicity and readability reasons. A person of ordinary skill in the art would have an understanding of such factors as, for example, inflation, interest, future present value, and the like.

According to embodiments of the invention, a computer system may include one or more components that may include a bus a processor, a memory, a read only memory (ROM) a datastore, an input device, an output device, and a communication interface. Bus may include one or more interconnects that permit communication among the components of computer system, such as processor, memory, ROM, datastore, input device, output device, and communication interface.

The processor or host processor may include any type of processor, microprocessor, or processing logic that may interpret and execute instructions (e.g., a field programmable gate array (FPGA)). The processor may comprise a single device (e.g., a single core) and/or a group of devices (e.g., multi-core). The processor may include logic configured to execute computer-executable instructions configured to implement one or more embodiments. The instructions may reside in the datastore, memory, or ROM, and may include associated instructions.

Memory may be a computer-readable medium that may be configured to store instructions configured to implement one or more embodiments. The memory may be a primary storage accessible to the processor and may comprise a random-access memory (RAM) that may include RAM devices, such as Dynamic RAM (DRAM) devices, flash memory devices, Static RAM (SRAM) devices, etc.

ROM may include a non-volatile storage that may store information and computer-executable instructions for processor. The computer-executable instructions may include instructions executed by processor.

The Datastore may be configured to store information and instructions for the processor. Examples of a datastore may include a magnetic disk, optical disk, flash drive, etc. The information and computer-executable instructions and information may be stored on a medium contained in the storage device. Examples of media may include a magnetic disk, optical disk, flash memory, etc. The datastore may include a single storage device or multiple storage devices. Moreover, the datastore may attach directly to computer system and/or may be remote with respect to computer system and connected thereto via a network and/or another type of connection, such as a dedicated link or channel.

An input device may include any mechanism or combination of mechanisms that may permit information to be input into computer system from, e.g., a user. Input device may include logic configured to receive information for computer system from, e.g. a user. Examples of input device may include a keyboard, mouse, touch sensitive display device, microphone, pen-based pointing device, and/or biometric input device, etc.

Output device may include any mechanism or combination of mechanisms that may output information from computer system. Output device may include logic configured to output information from computer system. Embodiments of output devices may include displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc.

Communication interface may include logic configured to interface computer system with network and enable computer system to exchange information with other entities connected to network, such as, for example, service provider, target environment and cluster. Communication interface may include any transceiver-like mechanism that enables computer system to communicate with other devices and/or systems, such as a client, a server, a license manager, a vendor, etc. The communications may occur over a communication medium, such as a data network. Communication interface may include one or more interfaces that are connected to the communication medium. The communication medium may be wired or wireless. Communication interface may be implemented as a built-in network adapter, network interface card (NIC), Personal Computer Memory Card International Association (PCMCIA) network card, card bus network adapter, wireless network adapter, Universal Serial Bus (USB) network adapter, modem or any other device suitable for interfacing computer system to any type of network.

It will be understood that the above description of the present invention and attachments are susceptible to various modifications, changes and adaptations, and the same are intended to be comprehended within the meaning and range of equivalents of the appended claims.

What is claimed is:

1. A protection plan computer system for protecting a purchase price of real estate to minimize liability risk associated with a loss of value of the real estate, the system comprising:
a host processor adapted to receive and transmit data;
a datastore associated with the host processor, the datastore to receive and store data from the host processor, the data including information on at least one inventory of real estate, a start date for at least one unit of the at least one inventory, and predetermined threshold information, wherein the host processor includes computer executable instruction for:
selecting the at least one inventory of real estate for processing;
calculating and storing a protected price of the at least one unit in the datastore;
determining and storing an exercise option in the datastore for the at least one unit based on the start date and the protected price;
determining and storing an opt-out option in the datastore based on the start date and the protected price; and
outputting at least one of (a) a first output or an exercise failure output based on the exercise option or (b) a second output or an opt-out failure output based on the opt-out option.

2. The system according to claim 1, wherein the information on the at least one unit in the datastore includes a unit count of at least one inventory of real estate, a value of sold units in the inventory, and a price per square foot for each unit in the datastore.

3. The system according to claim 2, wherein the information on the at least one unit in the datastore further includes a square footage of the at least one unit and at least one of a discount factor or premium factor of each unit.

4. The system according to claim 2, wherein the selecting at least inventory comprises:
matching the unit count to a threshold unit count of the predetermined threshold information stored in the datastore, wherein the threshold unit count includes an associated threshold value and an associated threshold price;
comparing the value to the threshold value and comparing the price per square foot to the threshold price; and
selecting the inventory and the at least one unit of the inventory for the processing if both the value is greater than or equal to the threshold value and the price per square foot is greater than or equal to the threshold price.

5. The system according to claim 3, wherein the calculate and store a protected price further comprises:
multiplying the square footage of the at least one unit by the price per square foot to determine a base price of each unit,
multiplying the base price by the sum of one plus the premium factor to obtain the protected price; and
storing the protected price of each unit in the datastore.

6. The system according to claim 3, wherein the calculate and store a protected price further comprises:
multiplying the square footage of the at least one unit by the price per square foot to determine a base price of each unit, wherein the base price is equal to the protected price; and
storing the protected price of each unit in the datastore.

7. The system according to claim 1, wherein the determine an exercise option further includes:
determining an exercise date for the at least one unit of the selected inventory by adding a time unit stored in the datastore to the start date and storing the exercise date associated with the respective unit in the datastore,
determining an exercise-action date for the at least one unit of the selected inventory by adding a second time unit stored in the datastore to the start date, and
associating the exercise-action date with the protected price of the at least one unit.

8. The system according to claim 1, wherein the information further includes an opt-out percentage, a request-option associated with a request-date, and an option index.

9. The system according to claim 8, wherein the determine and store an opt-out option further includes:
determining at least one opt-out date for the at least one unit of the selected inventory by adding at least one further time unit stored in the datastore to the start date and storing the at least one opt-out date in the datastore, and
calculating an opt-out payout including multiplying the protected price by the opt-out percentage and storing the opt-out payment in the datastore.

10. The system according to claim 7, wherein the information further includes a request-date for the at least one unit of the selected inventory, an opt-out percentage, a request-option associated with the request-date, and an option index, wherein the determine and store an opt-out option further includes:
determining at least one opt-out date for the at least one unit of the selected inventory by adding at least one further time unit stored in the datastore to the start date and storing the at least one opt-out date in the datastore, and
calculating an opt-out payout including multiplying the protected price by the opt-out percentage and storing the opt-out payment in the datastore.

11. The system according to claim 10, wherein the output includes:
comparing the request-option to the option index, wherein the option index includes a first value associated with the exercise option and a second value associated with the opt-out option;
matching the request-option with one of the first value or the second value,
outputting one of (a) the first output if the request-option matches the first value and the request-date precedes or is equal to the exercise date associated with the at least one unit or (b) a exercise failure output if the request-option matches the first value and the request-date exceeds the exercise date associated with the at least one unit; and
outputting one of (c) the second output if the request-option matches the second value and the request-date precedes or is equal to the at least one opt-out date associated with the at least one unit or (d) a opt-out failure output if the request-option matches the second value and the request-date exceeds the at least one opt-out date associated with the at least one unit.

12. The system according to claim 11, wherein the first output at least includes the exercise-action date with the protected price of the unit and the second output includes the opt-out payout.

13. The system according to claim 5, wherein the host processor is adapted to calculate a program cost my subtracting the base price from the protected price and is adapted to store the program cost in the datastore.

14. The system according to claim 6, wherein the host processor is adapted to calculate a program cost by multiplying the base price by the discount factor to obtain a cost of the protection plan system; and the host processor is adapted to store the cost of the protection plan system in the datastore.

15. The system according to claim 13, wherein the cost of the protection plan comprises an operational portion and an investment amount, wherein the host processor calculates the operational portion by multiplying an operational factor by the cost of the protection plan and stores the operational portion in the datastore, and wherein the host processor calculates the investment amount by subtracting the operational portion from the cost of the protection plan.

16. The system according to claim 15, wherein the datastore includes a residual value of the at least one unit and a portfolio amount based on the investment amount, wherein the host processor is further adapted to:
determine a profit or shortfall based on the residual value and the portfolio amount, wherein the determine further includes
calculate a result by adding the portfolio amount to the residual value;
store the result in the datastore as the profit if the result is greater than or equal to the protected price or store the result in the datastore as the shortfall if the result is less than the protected price;
and output the result.

17. The system according to claim 1, wherein the protected price is embedded with a base price and an amount attributed to protecting the at least one unit from value instability.

18. The system according to claim 16, wherein the output result comprises outputting a signal denoting profit or a signal denoting shortfall with a value of the result.

19. A computer program product, saved on a memory connected to a computer, to protect a purchase price of real estate to minimize liability risk associated with a loss of value of the real estate, wherein said computer program product includes programs by which the computer executes the steps of:
selecting at least one inventory of real estate inventory for processing;
calculating a protected price of at least one unit of the selected at least one inventory;
determining an exercise option for the at least one unit based on the start date and the protected price;
determining an opt-out option based on the start date and the protected price; and
outputting at least one of (a) a first output or an exercise failure output based on the exercise option or (b) a second output or an opt-out failure output based on the opt-out option.

20. A method to protect a purchase price of real estate to minimize liability risk associated with a loss of value of the real estate, comprising:
selecting at least inventory of real estate for processing by a computer;
calculating and storing, by a computer, a protected price of at least one unit of the at least one inventory in a datastore;
determining and storing, by a computer, an exercise option in the datastore for the at least one unit based on a start date and the protected price;
determining and storing, by a computer, an opt-out option in the datastore based on the start date and the protected price; and
outputting, by a computer, at least one of (a) a first output or an exercise failure output based on the exercise option or (b) a second output or an opt-out failure output based on the opt-out option.
